(19) United States
(12) Patent Application Publication
(10) Pub. No.: US 2007/0227068 A1
(43) Pub. Date: Oct. 4, 2007

(54) Wraparound flower planter

(76) Inventor: Russell Cataldi, Maple Glen, PA (US)

Correspondence Address: LITMAN LAW OFFICES, LTD., P.O. BOX 15035, CRYSTAL CITY STATION, ARLINGTON, VA, 22215, US

(21) Appl. No.: 11/727,185

(22) Filed: Mar. 23, 2007

Related U.S. Application Data
(60) Provisional application No. 60/786,711, filed on Mar. 29, 2006.

(51) Int. Cl. A01G 9/02

(52) U.S. Cl. 47/66.1; 47/66.6

(57) ABSTRACT

The wraparound flower planter includes two almost-identical semicylindrical members and releasable fasteners for securing the two members together so that the wraparound flower planter is maintained in a closed position around the base of a tree, or other columnar support. Each of the semicylindrical pot members has an open upper end, an open lower end, and a surrounding sidewall. A pair of diametrically opposed interior planar walls extend radially inward from the sidewall. A substantially semicylindrical inner wall coaxial with the sidewall extends between inner edges of the interior planar walls from the open upper end to the bottom edge of the interior planar walls, defining a cylindrical channel extending through the pot. A shelf extends between the sidewall and the inner wall, forming the floor of a generally U-shaped peripheral channel. The shelf has a plurality of drainage apertures disposed therethrough.

### CROSS-REFERENCE TO RELATED APPLICATION

This application claims the benefit of U.S. Provisional Patent Application Ser. No. 60/786,711, filed Mar. 29, 2006.

### BACKGROUND OF THE INVENTION

1. Field of the Invention

The present invention relates to flower pots and planters, and more specifically to a wraparound flower planter that is adapted to fit around the base of a tree or other similar object.

2. Description of the Related Art

It is oftentimes desirable to place smaller plants and flowers around the base of taller objects, such as trees, mailboxes, light posts, and flag poles, that are found outdoors in order to increase the aesthetic appeal of these outdoor areas. While flower pots and planters are well known in the art, no such device effectively allows a user to display potted plants in a planter that surrounds the base of a tree, or other similar device having a post. It is desirable that such a device be capable of accepting plants or flowers that are to be potted within the device, as well as plants and flowers that are already potted. It is also desirable that the device be capable of being easily and quickly secured around the base of a tree, or other object. Thus, a wraparound flower planter solving the aforementioned problems is desired.

### SUMMARY OF THE INVENTION

The wraparound flower planter includes two almost-identical, symmetrical semicylindrical members and means for securing the two members together so that the wraparound flower planter is maintained in a closed position around the base of a tree, or other similar device having a post or columnar base.

Each of the semicylindrical pot members has an open upper end, an open lower end, and a surrounding sidewall. The surrounding sidewall extends between the open upper end and the open lower end. A pair of diametrically opposed interior planar walls extend radially inward from the sidewall and extend from the open upper end to a medial portion of the sidewall. A substantially semicylindrical inner wall coaxial with the sidewall extends between inner edges of the interior planar walls from the open upper end to the bottom edge of the interior planar walls, defining a cylindrical channel extending through the pot. A shelf extends between the bottom edges of the interior planar walls and between the sidewall and the inner wall, forming the floor of a generally U-shaped peripheral channel. The shelf has a plurality of drainage apertures disposed therethrough. Pairs of diametrically planar tabs coplanar with the interior planar walls extend radially inward from the sidewall at the open lower end.

The means for securing the two members together is disposed along each of the interior planar walls so that the wraparound flower planter is maintained in a closed position along a single, shared surface. These and other features of the present invention will become readily apparent upon further review of the following specification and drawings.

### BRIEF DESCRIPTION OF THE DRAWINGS

FIG. 1 is an environmental, perspective view of a wraparound flower planter according to the present invention.

FIG. 2 is an exploded, perspective view of a wraparound flower planter according to the present invention.

FIG. 3 is a perspective view of a first semicylindrical pot member of a wraparound flower planter according to the present invention.

FIG. 4 is a perspective view of a second semicylindrical pot member of a wraparound flower planter according to the present invention.

Similar reference characters denote corresponding features consistently throughout the attached drawings.

### DETAILED DESCRIPTION OF THE PREFERRED EMBODIMENTS

The present invention is a wraparound flower planter, designated generally as 10 in the drawings, for planting or displaying plants or flowers around the base of a tree, or other similar device having a post or columnar base.

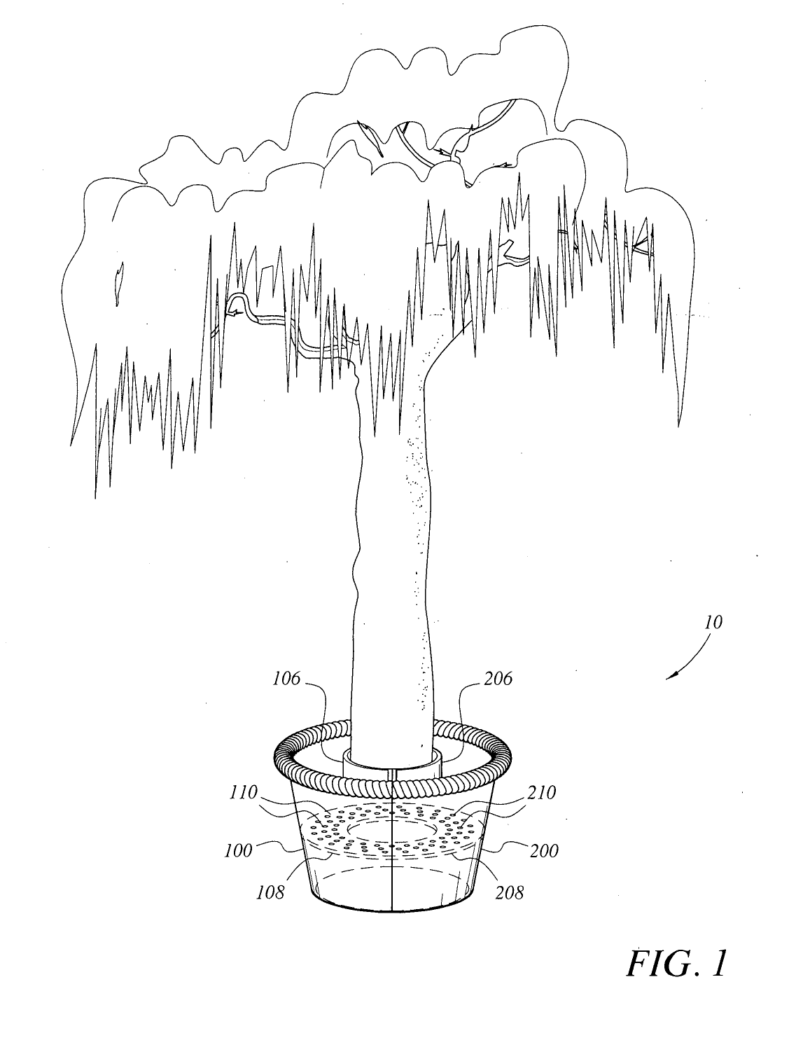

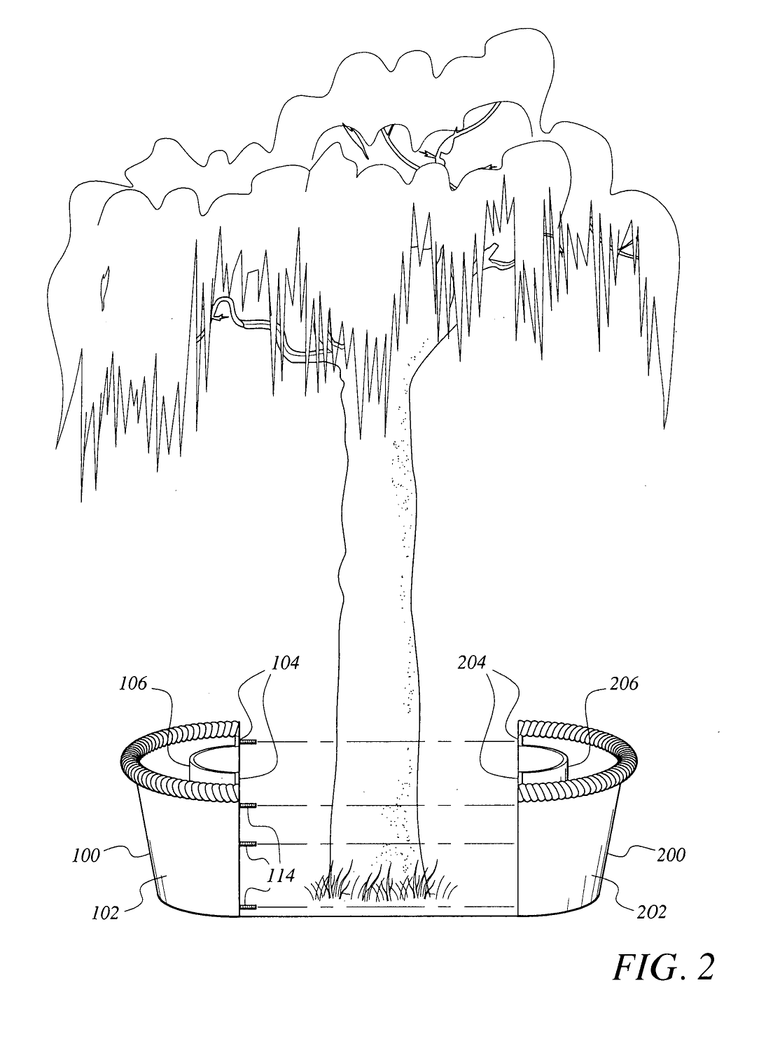

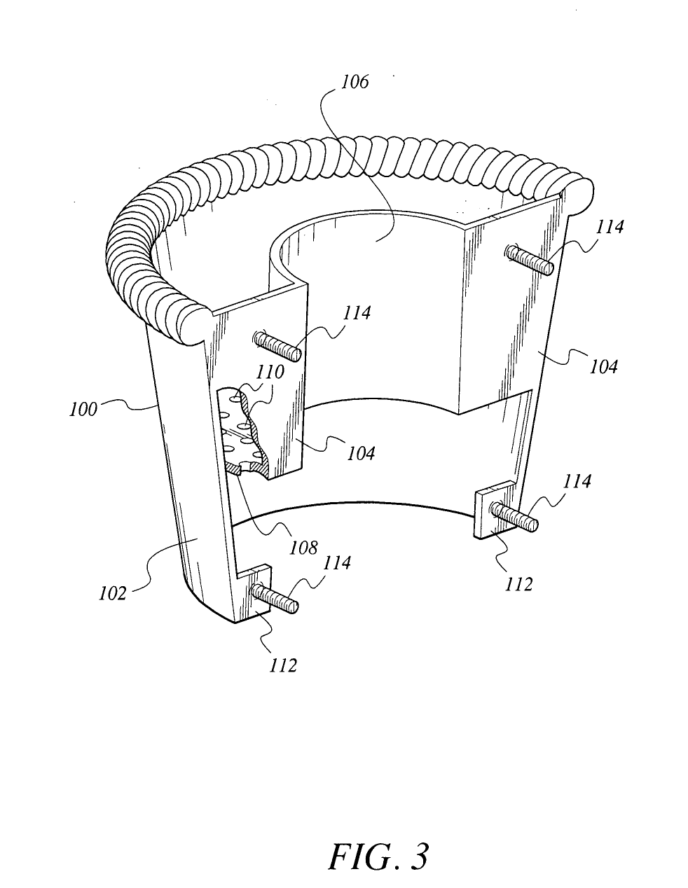

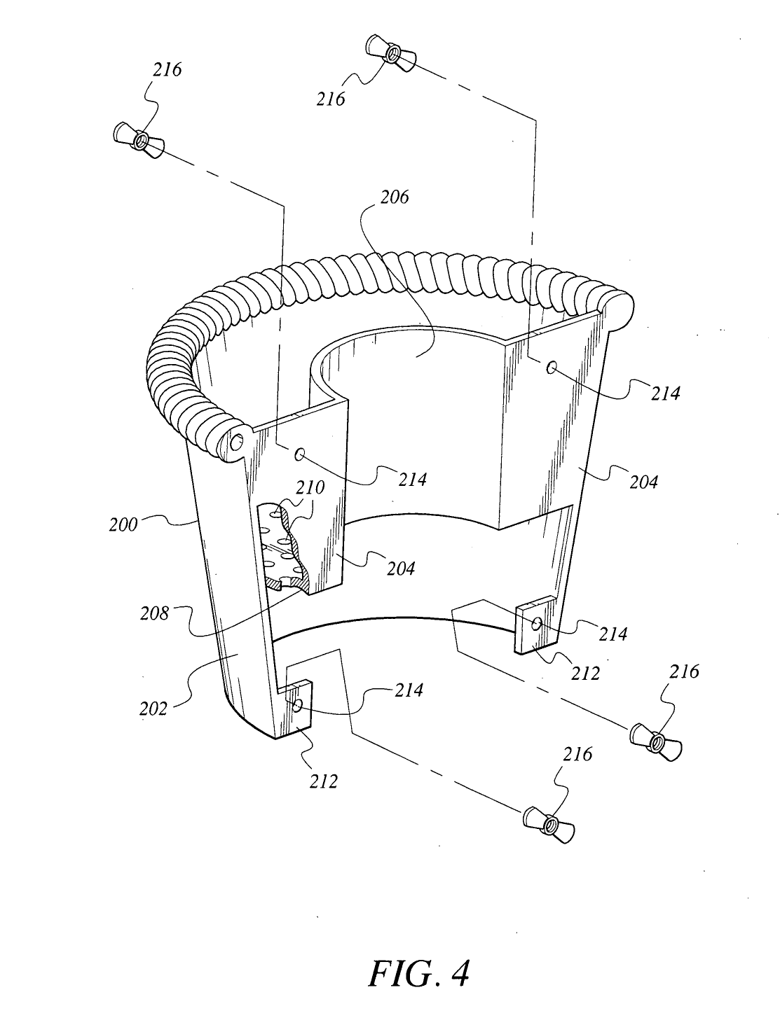

Referring to FIGS. 1-4, the wraparound flower planter 10 includes two almost-identical, symmetrical semicylindrical members; i.e., first semicylindrical pot member 100 and second semicylindrical pot member 200, and means for securing the two members together so that the wraparound flower planter is maintained in a closed position around the base of a tree, or other similar device having a post.

First semicylindrical pot member 100 has an open upper end, an open lower end, and a surrounding sidewall 102. Surrounding sidewall 102 extends between the open upper end and the open lower end. A pair of diametrically opposed interior planar walls 104 extend radially inward from sidewall 102 and downward from the upper end to a medial portion of the sidewall 102. A substantially semicylindrical inner wall 106 coaxial with sidewall 102 extends between the inner edges of interior planar walls 104 and from the open upper end down to the bottom edges of the interior planar walls 104, defining a semicylindrical cavity extending axially through pot member 100. Shelf 108 extends between the sidewall 102 and inner wall 106, and between the bottom edges of interior planar walls 104, forming the floor of a generally U-shaped peripheral channel. Shelf 108 has a plurality of drainage apertures 110 disposed therethrough. A diametrically opposed pair of planar tabs 112 extend radially inward from the open lower end coplanar to interior planar walls 104. The semicylindrical inner wall 106 and interior planar walls 104 may be formed as a single, integral, monolithic member by molding, casting, forging, or the like.

Second semicylindrical pot member 200 has an open upper end, an open lower end, and a surrounding sidewall 202. Surrounding sidewall 202 extends between the open upper end and the open lower end. A pair of diametrically opposed interior planar walls 204 extend radially inward from sidewall 202 and downward from the upper end to a medial portion of the sidewall 202. A substantially semicylindrical inner wall 206 coaxial with sidewall 202 extends between the inner edges of interior planar walls 204 and from the open upper end down to the bottom edges of the interior planar walls 204, defining a semicylindrical cavity extending axially through pot member 200. Shelf 208 extends between the sidewall 202 and inner wall 206, and between the bottom edges of interior planar walls 204, forming the floor of a generally U-shaped peripheral channel. Shelf 208 has a plurality of drainage apertures 210 disposed therethrough. A diametrically opposed pair of planar tabs 212 extend radially inward from the open lower end coplanar to interior planar walls 204. The semicylindrical inner wall 206 and interior planar walls 204 may be formed as a single, integral, monolithic member by molding, casting, forging, or the like.

When first semicylindrical pot member 100 and second semicylindrical pot member 200 are secured together to form wraparound flower planter 10, inner walls 106 and 206 provide a centrally-located cylindrical channel through which the base of a tree trunk or other post may extend. Shelves 108 and 208 provide a platform for plants or flowers that can be positioned around the centrally located cylindrical channel for decorative appeal. The plants or flowers can be pre-potted plants or flowers that can be arranged on shelves 108 or 208.

In the alternative, the open area above shelves 108 and 208 can be filled with potting soil and plants or flowers may be planted directly into wraparound flower planter 10. Drainage apertures 110 and 210 are provided through shelves 108 and 208 for allowing water from these plants or flowers to drain into the ground below wraparound flower planter 10. Apertures 110 and 210 may be permanent or may be provided as knockout apertures that can be plugged when desired. Although pot halves 100 and 200 have been described as semicylindrical, it will be understood that sidewalls 102 and 202 may taper inward from the open upper end to the open lower end, giving planter 100 a frustoconical or slightly frustoconical shape typical of flower pots.

In a preferred embodiment, means for securing first semicylindrical pot member 100 and second semicylindrical pot member 200 together so that wraparound flower planter 10 is maintained in a closed position include a plurality of externally threaded fasteners 114, such as threaded bolts, studs, or the like, and wing nuts 216. Two fasteners 114 are permanently secured through, or extend from, interior planar wall 104 of first semicylindrical pot member 100 and two fasteners are secured through, or extend from, planar tabs 112 of interior planar wall 104 of first semicylindrical pot member 100.

Fasteners 114 correspond to holes 214 that are located through interior planar wall 204 of second semicylindrical pot member 200 and planar tabs 212 of second semicylindrical pot member 200. After first semicylindrical pot member 100 and second semicylindrical pot member 200 are approximated so that wraparound flower planter 10 is formed in a closed position along a single, shared surface, wing nuts 216 are used to secure the device in the closed position. Sidewalls 102 and 202 may have any desired external ornamentation.

It is to be understood that the present invention is not limited to the embodiments described above, but encompasses any and all embodiments within the scope of the following claims.

I claim:

1. A wraparound flower planter, comprising:
first and second substantially semicylindrical pot members, each of the pot members having:
a sidewall defining an open upper end and an open lower end;
a pair of diametrically opposed interior planar walls extending radially inward from the sidewall and from the open upper end to a medial portion of the sidewall, each of the interior planar walls having a bottom edge and an interior edge;
a substantially inner wall coaxial with the sidewall extending between the interior edges of the interior planar walls and from the open upper end to the bottom edges of the interior planar walls, the inner wall having a bottom edge, the inner wall defining a substantially semicylindrical recess;
a shelf extending between the medial portion of the sidewall and the bottom edge of the inner wall and between the bottom edges of the interior planar walls, the sidewall, inner wall and shelf defining a semicylindrical U-shaped channel adapted for supporting potted plants and plants to be potted; and
a pair of diametrically opposed planar tabs extending radially inward from the open lower end coplanar with the interior planar walls; and
means for fastening the first semicylindrical pot member to the second semicylindrical pot member so that the wraparound flower planter is maintained in a closed configuration, the two semicylindrical recesses merging to form a semicylindrical channel adapted for placement around a columnar base.

2. The wraparound flower planter as recited in claim 1, wherein each of the planar tabs of said first and second semicylindrical pot members has a hole defined therein.

3. The wraparound flower planter as recited in claim 2, wherein said means for securing the first semicylindrical pot member to the second semicylindrical pot member comprises at least one pair of threaded bolts and at least one pair of threaded nuts, the at least one pair of threaded bolts extending through the holes defined in the pairs of planar tabs of said first and second semicylindrical pot members when said wraparound flower planter is in the closed configuration.

4. The wraparound flower planter as recited in claim 3, wherein the at least one pair of threaded bolts comprises first and second pairs of threaded bolts, the first pair of threaded bolts extending through the pairs of planar tabs of said first and second semicylindrical pot members when said wraparound flower planter is in the closed configuration, the second pair extending through respective holes formed through the interior planar walls of said first and second semicylindrical pot members.

5. The wraparound flower planter according to claim 3, wherein said nuts comprise wing nuts, whereby the nuts may be tightened by hand.

6. The wraparound flower planter as recited in claim 1, wherein each shelf of the first and second semicylindrical pot members has a plurality of drainage apertures formed therethrough.

7. The wraparound flower planter as recited in claim 1, wherein said sidewall is slightly tapered inward from the open upper end to the open lower end, whereby the planter has a frustoconical shape simulating a flower pot in appearance.

8. A wraparound flower planter, comprising:
first and second substantially semicylindrical pot members, each of the pot members having:
a sidewall defining an open upper end and an open lower end;
a pair of diametrically opposed interior planar walls extending radially inward from the sidewall and from the open upper end to a medial portion of the sidewall, each of the interior planar walls having a bottom edge and an interior edge;
a substantially inner wall coaxial with the sidewall extending between the interior edges of the interior planar walls and from the open upper end to the bottom edges of the interior planar walls, the inner wall having a bottom edge, the inner wall defining a substantially semicylindrical recess;
a shelf extending between the medial portion of the sidewall and the bottom edge of the inner wall and between the bottom edges of the interior planar walls, the sidewall, inner wall and shelf defining a semicylindrical U-shaped channel adapted for supporting potted plants and plants to be potted; and
a pair of diametrically opposed planar tabs extending radially inward from the open lower end coplanar with the interior planar walls; and
releasable fasteners joining the first semicylindrical pot member to the second semicylindrical pot member so that the wraparound flower planter is maintained in a closed configuration, the two semicylindrical recesses merging to form a semicylindrical channel adapted for placement around a columnar base.

9. The wraparound flower planter as recited in claim 8, wherein each of the planar tabs of said first and second semicylindrical pot members has a hole defined therein.

10. The wraparound flower planter as recited in claim 8, wherein said means for securing the first semicylindrical pot member to the second semicylindrical pot member comprises at least one pair of threaded bolts and at least one pair of threaded nuts, the at least one pair of threaded bolts extending through the holes defined in the pairs of planar tabs of said first and second semicylindrical pot members when said wraparound flower planter is in the closed configuration.

11. The wraparound flower planter as recited in claim 10, wherein the at least one pair of threaded bolts comprises first and second pairs of threaded bolts, the first pair of threaded bolts extending through the pairs of planar tabs of said first and second semicylindrical pot members when said wraparound flower planter is in the closed configuration, the second pair extending through respective holes formed through the interior planar walls of said first and second semicylindrical pot members.

12. The wraparound flower planter according to claim 10, wherein said nuts comprise wing nuts, whereby the nuts may be tightened by hand.

13. The wraparound flower planter as recited in claim 8, wherein each shelf of the first and second semicylindrical pot members has a plurality of drainage apertures formed therethrough.

14. The wraparound flower planter as recited in claim 8, wherein said sidewall is slightly tapered inward from the open upper end to the open lower end, whereby the planter has a frustoconical shape simulating a flower pot in appearance.

15. The wraparound flower planter according to claim 8, wherein said the interior planar walls and planar tabs of second semicylindrical pot member have holes defined therein, said releasable fasteners comprise:
threaded studs extending from the interior planar walls and panel tabs of said first semicylindrical pot member and extendable through the holes defined in the interior planar walls and planar tabs of said second semicylindrical pot member; and
wing nuts threadable onto the threaded studs to fasten said first and second semicylindrical pot members together.

16. The wraparound flower planter according to claim 8, wherein said inner wall and said interior planar walls are formed as a single, monolithic member.

17. A wraparound flower planter, comprising:
a pair of symmetrical exterior sidewall members forming a tubular container sidewall when joined together;
a pair of symmetrical semicylindrical collar members having mounting flanges extending radially therefrom in diametrically opposite directions, the mounting flanges being joined to the tubular container sidewall to form a cylindrical collar adapted for placement around a tree trunk when the exterior sidewall members are joined together;
a shelf extending between the collar and the tubular sidewall, the shelf being adapted for supporting potted plants; and
a plurality of releasable fasteners joining the exterior sidewall members together.

18. The wraparound flower planter according to claim 17, wherein said tubular container sidewall is cylindrical.

19. The wraparound flower planter according to claim 17, wherein said tubular container sidewall forms a frustoconical, pot-shaped container.
